(19) United States
(12) Patent Application Publication
(10) Pub. No.: US 2020/0133884 A1
(43) Pub. Date: Apr. 30, 2020

(54) NVRAM SYSTEM MEMORY WITH MEMORY SIDE CACHE THAT FAVORS WRITTEN TO ITEMS AND/OR INCLUDES REGIONS WITH CUSTOMIZED TEMPERATURE INDUCED SPEED SETTINGS

(71) Applicant: Intel Corporation, Santa Clara, CA (US)

(72) Inventors: Zeshan A. CHISHTI, Hillsboro, OR (US); Somnath PAUL, Hillsboro, OR (US); Charles AUGUSTINE, Portland, OR (US); Muhammad M. KHELLAH, Tigard, OR (US)

(21) Appl. No.: 16/721,412

(22) Filed: Dec. 19, 2019

(51) Int. Cl. G06F 12/123

(52) U.S. Cl. CPC G06F 12/123; G06F 2212/1016

(57) ABSTRACT

An apparatus is described. The apparatus includes a memory controller to interface with a memory side cache and an NVRAM system memory. The memory controller has logic circuitry to favor items cached in the memory side cache that are expected to be written to above items cached in the memory side cache that are expected to only be read from.

### FIELD OF INVENTION

The field of invention pertains generally to the computing sciences, and, more specifically, to an NVRAM system memory with memory side cache that favors written to items.

### BACKGROUND

Computing system designers and the designers of components that are to be integrated into such systems are continually seeking ways to make the systems/components they design more efficient.

### FIGURES

A better understanding of the present invention can be obtained from the following detailed description in conjunction with the following drawings, in which:

FIG. 1 shows an SOC;

FIG. 2 shows an improved memory side cache caching algorithm;

FIG. 3 show a memory controller that can execute the caching algorithm of FIG. 2;

FIG. 4 shows an NVRAM with different sections;

FIG. 5 shows a computing system.

### DETAILED DESCRIPTION

One approach to address system inefficiencies is to construct a system memory (also referred to as main memory) composed at least partially with an emerging non-volatile random access memory (NVRAM). Emerging NVRAM technologies are characterized as having read latencies that are significantly faster than traditional non volatile mass storage such as hard disk drives or flash solid state drives so as to be suitable for system memory use.

Emerging NVRAM technologies also can support finer grained accessing granularities than traditional non volatile mass storage. For example, various emerging NVRAM memory technologies can be accessed at CPU cache line granularity (e.g., 64 bytes) and/or can be written to and/or read from at byte level granularity (byte addressable), whereas, traditional non volatile mass storage devices can only be accessed at much larger granularities (e.g., read from in 4 kB “pages”, programmed/written to and/or erased in even larger “sectors” or “blocks”). The finer access granularity, again, makes NVRAM suitable for system memory usage (e.g., because CPU accesses to/from system memory are typically made at cache line and/or byte addressable granularity).

The use of emerging NVRAM memory in a main memory role can offer efficiency advantages for an overall computing system such as the elimination and/or reduction of large scale internal traffic flows and associated power consumption concerning “write-backs” or “commitments” of main memory content back to mass storage.

Emerging NVRAM memory technologies are often composed of three dimensional arrays of storage cells that are formed above a semiconductor chip's substrate amongst/within the chip's interconnect wiring. Such cells are commonly resistive and store a particular logic value by imposing a particular resistance through the cell (e.g., a first resistance corresponds to a first stored logical value and a second resistance corresponds to a second stored logical value). Examples of such memory include, among possible others, Optane™ memory from Intel Corporation, phase change memory, resistive random access memory, dielectric random access memory, ferroelectric random access memory (FeRAM) and spin transfer torque random access memory (STT-RAM).

Because emerging NVRAM memory cells are typically manufactured above a semiconductor chip substrate amongst the chip's interconnect wiring, NVRAM memory macros can be integrated on a high density logic chip such as a system-on-chip (SOC) having, e.g., multiple processing cores.

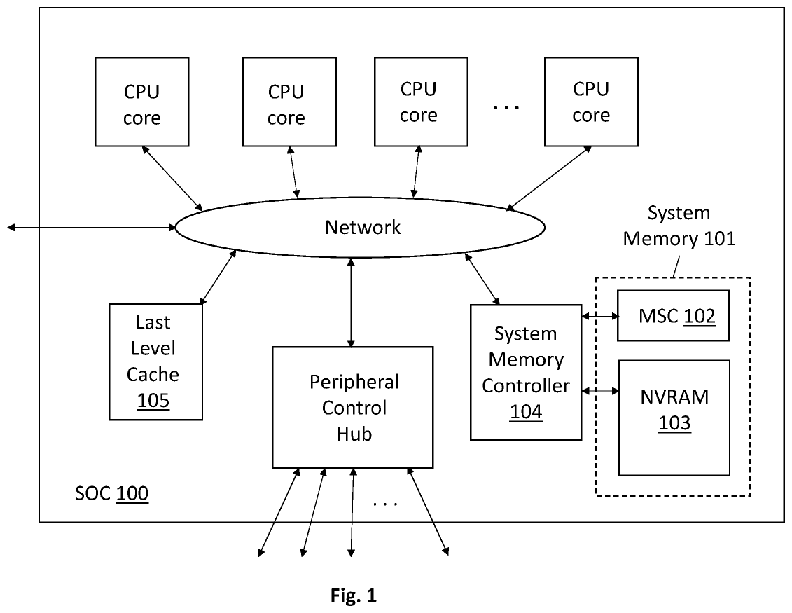

Although emerging NVRAM technologies have significantly shorter access times, at least for reads, than traditional non volatile mass storage devices, they are nevertheless slower than traditional volatile system memory technologies such as DRAM. One approach to making an NVRAM based system memory appear faster to a system component that uses system memory, as observed in FIG. 1, is to place a memory side cache 102 composed of a faster volatile memory (e.g., SRAM, DRAM) between the NVRAM based system memory 101 and the rest of the system.

Technically, the memory side cache 102 is an upper level of system memory 101 because it keeps the system memory's more frequently accessed items (e.g., cache lines) rather than just the items that are most frequently accessed by the CPU core(s). The CPU caching hierarchy, by contrast, keeps the later. The CPU caching hierarchy typically includes a first level (L1) cache for each instruction execution pipeline (there is typically multiple such pipelines per CPU core), a second level cache for each CPU core, and, a last level cache 105 for the CPU cores that reside on a same SOC. For illustrative ease only the latter is drawn and labeled.

As such, the memory side cache 102 is apt to keep items that are frequently accessed by system components other than the CPU core(s) (e.g., graphics processing units (GPU(s), accelerators, network interfaces, mass storage devices, etc.) which conceivably could compete with CPU cache lines for space in the memory side cache 102.

FIG. 1 shows the memory side cache 102 and NVRAM 103 being embedded on the same semiconductor chip as the multi-CPU core system on chip (SOC) 100. In alternate implementations both the memory side cache and NVRAM can be off the SOC, e.g., as dual-in-line memory modules (DIMMs) that are coupled to the SOC (e.g., DIMMs that are compatible with an (e.g., JEDEC) industry standard dual data rate (DDR) protocol). Having the memory side cache and NVRAM integrated on the SOC die 100, however, will have reduced access latencies as compared to an off die solution. For ease of discussion the remainder of this description will mainly refer to an on-die memory side cache and NVRAM solution as depicted in FIG. 1.

Here, by keeping the items that are more frequently accessed in system memory 101 in the faster memory side cache 102, the system memory 101 as a whole will appear to the users of system memory 101 as being faster than the inherent read/write latencies of the NVRAM memory 103 that resides in the second, lower level of system memory 101.

Another characteristic of emerging NVRAM technologies is that the write latency can be significantly longer than the read latency. That is, to the extent emerging NVRAM technologies have access speeds that are comparable to system memory speeds (as opposed to traditional non volatile mass storage speeds), typically, NVRAM read access speeds are more comparable for system memory purposes than NVRAM write access speeds.

With the existence of a memory side cache 102, the system memory controller 104 includes eviction policy logic (not depicted) to evict items from the memory side cache 102 and enter them into the NVRAM 103 (in various embodiments, NVRAM 103 has recognized system memory address space but the memory side cache 102 does not).

Known eviction policies for the memory side cache 102 treat clean data no differently than dirty data (clean data is data items in the cache 102 that have not been written to). That is, for example, the least recently used (LRU) eviction policy will evict items from the memory side cache 102 that are least recently used irrespective of whether the least recently items are dirty or clean. Similarly, the least frequently used (LFU) eviction policy will evict the cached items that are less frequently used irrespective of whether the less frequently used cache items are dirty or clean.

However, with NVRAM 103 write speeds being noticeably slower than NVRAM read speeds, it makes sense to keep items in the memory side cache 102 that are expected to be written to at the expense of other items that are expected to only be read (including items that are expected to be more frequently read than the written to items are written to). Here, if items that are more frequently read are evicted from the memory side cache 102 before other items that are written to less frequently than the evicted read items, the penalty suffered reading the evicted items from NVRAM 103 is substantially less than the penalty that would be suffered if the written to items were instead evicted and written to in NVRAM 103. Said another way, if items are read from NVRAM 103 instead of the memory side cache 102, overall system memory 101 performance does not suffer as much than if the same number of items are written into NVRAM 103 instead of the memory side cache 102.

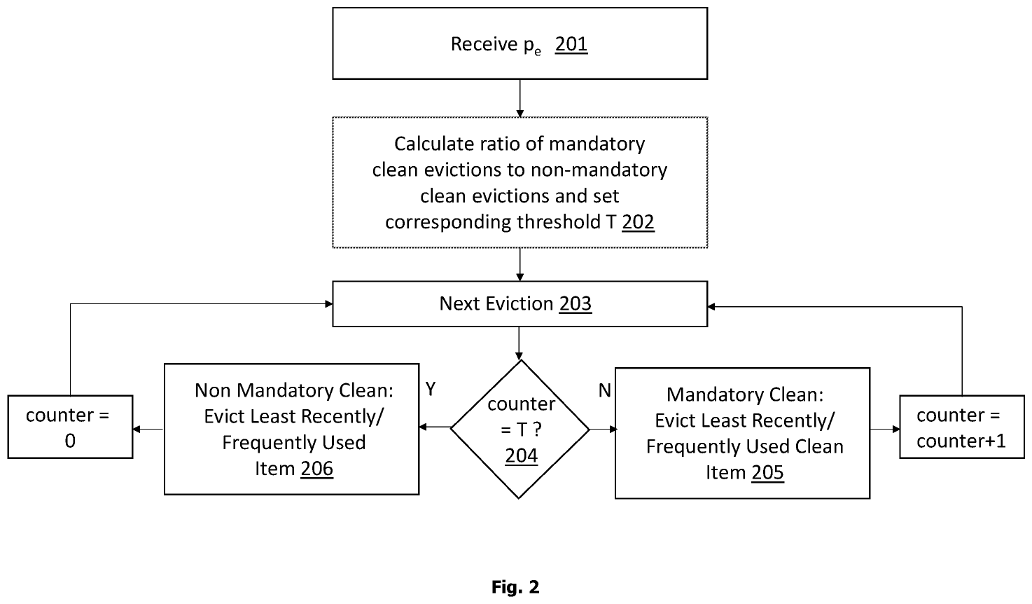

FIG. 2 shows a flow diagram for a cache eviction policy that can be used to keep written to items in the memory side cache at the expense of more frequently accessed “read-only” items. Notably, the cache eviction policy accepts 201 an input parameter, pₑ, that numerically expresses the degree to which the memory side cache is to favor keeping written to items at the expense of read-only items. At one extreme of the input parameter (e.g., pₑ=1.0), the memory side cache behaves more as a write buffer (only keeps data that is expected to be written to), while, at another extreme of the input parameter (e.g., pₑ=0.0), the memory side cache behaves more as a traditional cache that does not discriminate evictions between predictability of writes vs. predictability of reads.

In an embodiment, the pₑ setting determines the percentage of cache evictions that are reserved for clean items (“mandatory clean” evictions 205). Thus, for instance, if pₑ=0.8, 80% of cache evictions over time are reserved only for clean items. As will be described in more detail below, once the evictions reserved for clean items have taken place, the cache eviction policy falls back to a traditional eviction scheme (e.g., LRU, LFU) for the remaining 1−pₑ of evictions (“non mandatory clean” evictions 206). For example, again if pₑ=0.8, 1−pₑ=1−0.8=0.2, or, 20% of the remaining evictions are made according to an LRU or LFU policy.

Based on the pₑ setting, cache eviction logic of a system memory controller determines the ratio of mandatory clean evictions to non-mandatory clean evictions and sets a counter threshold based on the ratio 202. For example, if pₑ=0.8, the count threshold is set equal to pₑ/(1−pₑ)=0.8/0.2=4. That is, for every four mandatory clean evictions there is one non mandatory clean eviction.

According to one approach, once the memory side cache is full, a cache miss (either read or write) results in an automatic eviction from the memory side cache 102 because the missing item is called up from NVRAM 103 and entered into the cache 102. Although, as described in more detail below, variations to this basic cache insertion scheme can be implemented that incorporate the pₑ parameter or similar parameter.

Regardless, when an item needs to be inserted into an already full cache, an eviction 203 takes place and an item that is in the cache is chosen for eviction. According to an embodiment, the aforementioned counter counts evictions while only clean items are chosen for eviction 205 and the aforementioned counter increments with each eviction. Once, however, the count value reaches the threshold, an LRU or LFU based eviction is made 206. The counter then resets and the process repeats.

Thus, for example, if pₑ=0.8, the count threshold is set equal to pₑ/(1−pₑ)=0.8/0.2=4. As such, after every fourth clean item is evicted 205, the cache eviction policy selects the next item for eviction based on an LRU or LFU policy 206. The process then repeats with an LRU/LFU based eviction 206 being performed between groups of four sequential clean evictions 205.

In various embodiments, each cached item in the memory side cache 102 has associated meta data that includes a dirty bit that signifies whether the cached item has been written to or not. The meta data also includes the information needed to implement the fallback eviction policy scheme (e.g., LRU, LFU). According to one approach, LRU/LFU meta data is realized with one or more bits that are set if the cached item is accessed.

During a runtime window, meta data bits are set according to some LRU/LFU formula for those cached items that were accessed during the window. After the window expires the bits are cleared and the process repeats. At any time during a running window, the meta data bits will expose which cached items have been accessed during the current window (and to some extent, depending on the number of bits used, how recently and/or how frequently). Cached items without any set bit(s) are candidates for eviction because they have not been accessed during the window and therefore can be deemed to be least recently/frequently used.

In an embodiment, the memory side cache 102 is implemented as an associative or set associative cache so that the address of any cached item that is to be entered into the cache 102 maps to a number of different cache locations (“slots”) whose total entries likely include a mixture of dirty and clean items. For ease of discussion the remainder of the discussion will assume a set associative cache.

Depending on the state of the above described counter, in order to make room for the item to be inserted, one of the clean items from the set that the item's address maps to will be selected for eviction, or, the item in the set that has been least recently/frequently used will be selected for eviction. The former will take place if the counter has not reached the threshold, whereas, the later will take place if the counter has reached the threshold (or if there are no clean items to evict when a clean eviction is to take place).

Thus, in the case of a set associative cache, the insertion process entails mapping the address of the item to be inserted to the correct set of cached items, e.g., by performing a hash on the address which identifies the set, and then analyzing the meta data of the cached items within the set. According to an embodiment, if a clean item is to be selected for eviction, a least recently/frequently used clean item in the set is selected for eviction. By contrast, if a least recently/frequently used item is to be selected for eviction, a least recently/frequently used item in the set is selected for eviction irrespective of whether the item is clean or dirty.

Notably, the number of clean evictions per LRU/LFU eviction grows as pₑ increases. That is, if pₑ=0.5, every other eviction will be a clean eviction (the number of clean evictions equals the number of least recently/frequently used evictions). By contrast, if pₑ=0.8, as discussed above, there are four clean evictions per LRU/LFU eviction. Further sill, if pₑ=0.99, there are ninety-nine clean evictions per LRU/LFU eviction. Settings of pₑ=0.9 or higher, generally cause the memory side cache 102 to act more like a write buffer than a traditional cache because the cache eviction algorithm is favoring the presence of dirty items in the cache (which suggests they are more likely to be written to) over clean items (which suggests they are less likely to be written to).

The favoritism extended to dirty items should not severely impact overall memory performance by evicting items that are heavily read but not written to at least for pₑ settings at or below 0.8. For such pₑ settings, cached items that are recently/frequently being read and only being read nevertheless should remain in the memory side cache 102 because they will generally not be identified for eviction by either the clean selections (because least recently/frequently used clean items are selected for eviction and a recently/frequently accessed read only item will not be selected) or by least recently/frequently used selections (because, again, a frequently accessed item will not be selected).

As discussed above, the pₑ setting, or another similar parameter, can be used to determine whether or not a missed item should be inserted into the cache. For example according to one possible approach, insertions into the cache 102 stemming from a cache miss (the sought for item was not initially found in cache and had to be accessed from deeper NVRAM memory) favor write misses as opposed to read misses in proportion to the pₑ setting. That is, for example, if pₑ=0.8, 80% of cache insertions (or at least 80% of cache insertions) are reserved for a write cache miss and the remaining 20% of cache insertions can be, depending on implementation, for read misses only, or, some combination of write and read misses. For example, after four consecutive “write miss” based cache insertions, the fifth insertion can be, depending on implementation, only for a next read cache miss, or, whatever the next cache miss happens to be (read or write)).

In yet other implementations the percentage of cache insertions that are reserved for write cache misses is based on some function of pₑ such as Xpₑ where X is some fraction (e.g., 0.2, 0.4, 0.6, etc.). In various embodiments, X is fixed in hardware, or, like pₑ, can be configured in register space by software. In still yet other embodiments, the proportion of cache insertions that are reserved for cache write miss insertions relative to cache read miss evictions (or cache read miss or cache write miss evictions) is based on some other (e.g., programmable) parameter and/or formula.

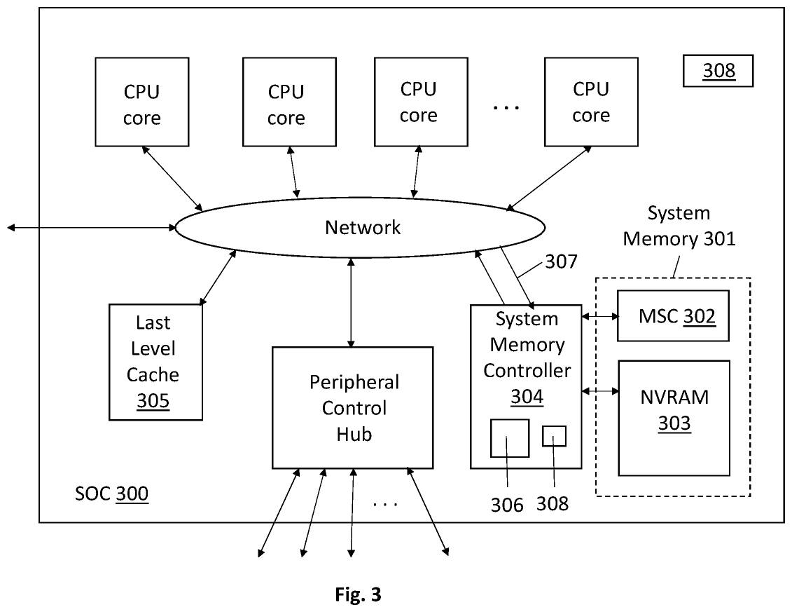

FIG. 3 shows a memory controller 304 that includes logic circuitry 306 to implement any of the embodiments described above. As observed in FIG. 3, the memory controller 304 is integrated, e.g., on a large system-on-chip (SOC) that includes multiple processing cores, a last level cache 305, on-die NVRAM system memory 303 and a peripheral control hub. The SOC also includes a static random access memory (SRAM) or embedded dynamic random access memory (eDRAM) that is used as a memory side cache 302 for the NVRAM system memory 303 as described at length above.

As mentioned just above, the memory controller 304 includes cache management logic circuitry 306 to implement any of the caching algorithms described above. According to a typical flow of operation, the memory controller 304 receives a read or write request at input 307. The request includes the system memory address of an item (e.g., cache line) that some other component of the computing system that the SOC is a part of desires from the system memory 301 on the SOC. The memory controller's cache logic management logic circuitry 306 performs a hash on the address which defines the set of cache slots in the memory side cache 302 that the item could be in—if it is in cache.

The memory side cache 302 includes slots for keeping cached data items and their corresponding meta data. That is, each slot has space for a cached data item and its meta data. The meta data includes in each slot for each cached data item: 1) a dirty bit that indicates whether the corresponding cached data item has been written to (the bit is set the first time the data item is written to in the cache); and, 2) one or more LRU/LFU bit(s) that indicate whether the cached data has been accessed or not (the number of such LRU/LFU bit(s) determine the granularity at which it can be determined how recently or how frequently an item has been accessed).

For example, according to one approach, multiple LFU bits are maintained in the meta data for a cached item so that a count of how many times a corresponding cached data item has been accessed can be explicitly counted. That is, the multiple bits effectively provide a mechanism for providing a least frequently used (LFU) basis for eviction rather than an LRU basis for eviction. For example, if eight LFU bits are present, the meta can count up to 256 accesses per cached data item. Providing more detailed LRU meta data allows the cache controller to more precisely determine exactly which cached data items are less frequently used than other cached data items in a same set (less frequently used cached data items will have lower meta data LRU count values).

In the case of LRU meta data, in various embodiments, multiple bits can be used to express a time stamp as to when the cached item was accessed. Cached items having an oldest time stamp are deemed to be least recently used. In a one bit LRU or LFU scheme, the one bit simply records whether the cached item has been accessed or not.

The meta data for each slot also includes tag information. A slot's tag meta data contains a subset of the system memory address of the slot's cached data item. Upon receiving a memory request at input 307 and hashing the request's system memory address to identify the correct set in the cache 302 where the sought for item will be, if it is in the cache 302, the cache management logic 306 scans the set's tag meta data to see if the sought for data item is in the set (the tag meta data for one of the slots matches the corresponding subset of the request's address).

If the sought for data item is in the set, the request is serviced from the cache 302. That is, if the request is a read request, the cached data item is forwarded to the component that issued the request (and any appropriate LRU/LFU meta data is updated for the cached data item). If the request is a write request, the cached data item is overwritten with data that was included with the write request (and the dirty bit is set if the cached data item was clean prior to the overwrite and any appropriate LRU/LFU meta data is updated).

If the item that is sought for by the received memory request is not in the memory side cache 302 (cache miss), the request is serviced from NVRAM 303. The cache management logic 306 handles any following cache insertions and corresponding cache evictions according to any of the embodiments described above. That is, according to one approach, any cache miss (whether read or write) results in the missed item being called up from NVRAM 303 and entered into the memory side cache 302. The cache management logic 306 then analyzes the meta data in the set that the miss mapped to and identifies a cached item for eviction.

Which item is identified for eviction depends, e.g., on a counter maintained by the cache management logic 306 that counts consecutive clean evictions. In various embodiments, any logic circuitry that maintains the counter is also coupled to register space 308 that contains a pₑ value that was previously set by software. As described above, in various embodiments, a count threshold maintained by the cache management logic 306 is determined from the pₑ value (e.g., threshold=(pₑ/(1−pₑ))).

If the counter value is less than the threshold when the cache eviction decision is being made, the least recently/frequently used clean data item in the set is chosen for eviction. The chosen item is then directly written over with the data item of the (missed) request that is being inserted into the memory side cache 302. Here, with the evicted item being clean, it need not be written back to NVRAM 303. If there are no clean items in the set and the least recently/frequently used dirty item is selected for eviction, the selected dirty item is read from its cache line slot and written back to NVRAM before being overwritten with the newly provided (missed) data item being inserted into the memory side cache 302.

If the counter value has reached the threshold, the cache management logic 306 selects the least recently/frequently used cached data item in the set for eviction irrespective of whether the item is dirty or not. If dirty, the evicted cached item is read from the memory side cache 302 before being overwritten by the newly inserted item and is written back to NVRAM 303. If clean, the evicted cached item is simply overwritten in the memory side cache 302 by the newly inserted item (no read or write back to NVRAM is performed).

In other approaches, as described above, the cache management logic 306 favors inserting the data items of write misses over read misses. For example, based on pₑ, and/or a second parameter (and/or formula) that is programmed into register space 308, the cache management logic 306 determines a ratio of how may write miss data items are to be inserted into the cache per read (or read or write) data item. A second threshold is established (from the aforementioned ratio) and a second counter is maintained. The cache management logic 306 only inserts missed write data items into the cache 302 and counts each time such insertion occurs until the second threshold is reached. Once the second threshold is reached the cache management logic 306 can insert the next read miss or whatever type of access the next miss happens to be (read or write).

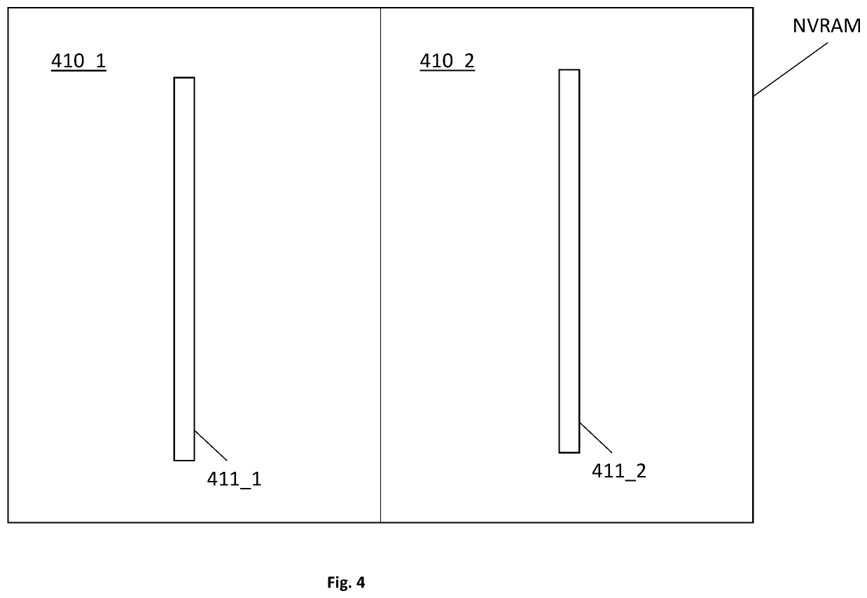

FIG. 4 shows an additional architectural feature that can be designed into an NVRAM in order to further compensate for the NVRAM's slower write latency. The architectural enhancement can be particularly helpful if the system memory is experiencing heavy write workloads that overwhelm the memory side cache. That is, if the memory side cache's capacity is not large enough to accommodate all the different items in system memory that are being written to, resulting in writes to NVRAM because of cache misses, there will be a “spill-over” effect of writes into NVRAM which, again, causes the system memory 301 to appear as being slower to the components that make requests to it. As such, the approach described herein with respect to FIG. 4 can be used in combination with a memory controller whose cache eviction policy favors keeping items that are expected to be written to in the memory side cache as described at length above.

As observed in FIG. 4, the NVRAM 403 is divided into different sections 410_1, 410_2 and each section can have its temperature precisely controlled by a heating element 411_1, 411_2. Here, it has been observed for at least some types of NVRAM (e.g., resistive RAM (RRAM), STT-RAM and Optane™ at least) that both read and write latencies are reduced as the temperature of the NVRAM cells increase (the NVRAM cells become faster as they gets hotter). The heating element 411_1, 411_2 in each region 410_1, 410_2 is designed to set the temperature of the NVRAM cells in the corresponding region according to a number of different temperature states.

Each region 410_1, 410_2 and the different number of temperature states per region is then translated into an NVRAM having different speed states. A particular speed state is then chosen for each NVRAM region 410_1, 410_2 based on the write workload the system memory is experiencing. For example, in a basic case, as depicted in FIG. 4, the NVRAM 403 has two region R1 410_1 and R2 420_2 and each of the R1 and R2 regions 410_1, 410_2 has two speed settings S1 and S2, where, the S2 state corresponds to a faster speed than the S1 state. In order for a region to reach the S2 state, its heating element is engaged to raise the temperature of the region so that the region will exhibit faster read and write times.

In an embodiment, during initial boot-up, both the R1 and R2 regions 410_1, 410_2 are placed in the slower S1 state. The system memory controller 304 then monitors write traffic being applied to the NVRAM 303. If a first threshold of NVRAM write traffic is crossed, the R1 region 410_1 is raised to the S2 state. If a second, higher threshold of write traffic is crossed, the R2 region 410_2 is raised to the S2 state. If the write traffic then falls between the first and second thresholds, the R2 region 410_2 is lowered to the S1 state (its heating element is configured to reduce its temperature). If the write traffic then falls below the first threshold the R1 region 410_1 is lowered to the S1 state.

Thus, the speed of the NVRAM 303 can be dynamically adjusted during its runtime based on observed workloads. In various embodiments, each region R1, R2 corresponds to contiguous region of system memory address space. The memory controller has associated register space 308 that allows software to raise/lower speed settings of different NVRAM regions. With knowledge of which regions of NVRAM 303 are faster than other NVRAM regions, the software (e.g., a virtual machine monitor or hypervisor, an operating system instance, etc.) can then map pages of more frequently written to and/or accessed data items to the faster NVRAM regions.

Raising the temperature of a region, however, reduces the retention times of the region's cells. That is, the cells will lose their stored data in less time if they are subjected to a higher temperature than if they were subjected to lower temperature. Because cell retention is accounted for irrespective of temperature, the memory controller includes scrubbing logic 308. Scrubbing logic 308 reads data from a cell prior to its data expiration time and writes the data back into the same cell (or another cell). So doing essentially refreshes the NVRAM with its own data (and, potentially, restarts the next retention time period after which data could be lost).

Because raising the temperature of a region reduces the retention time of the region's respective cells, when a region is raised to a higher speed state by raising its temperature, it should be scrubbed more frequently than when the region is in a lower/slower speed state. As such the benefit of increasing temperature and speed is offset somewhat by time spent scrubbing (a cell is unavailable while it is being scrubbed). Nevertheless, the increased read/write times of a higher speed setting result in a faster NVRAM region as compared to a lower speed setting even with increased scrubbing frequency at the higher speed region.

Although embodiments above have emphasized the NVRAM and memory side cache being implemented in a system memory role, note that any of the teachings above can be applied to an embedded NVRAM and memory side cache that are implemented on the SOC as a CPU cache, such as a last level CPU cache.

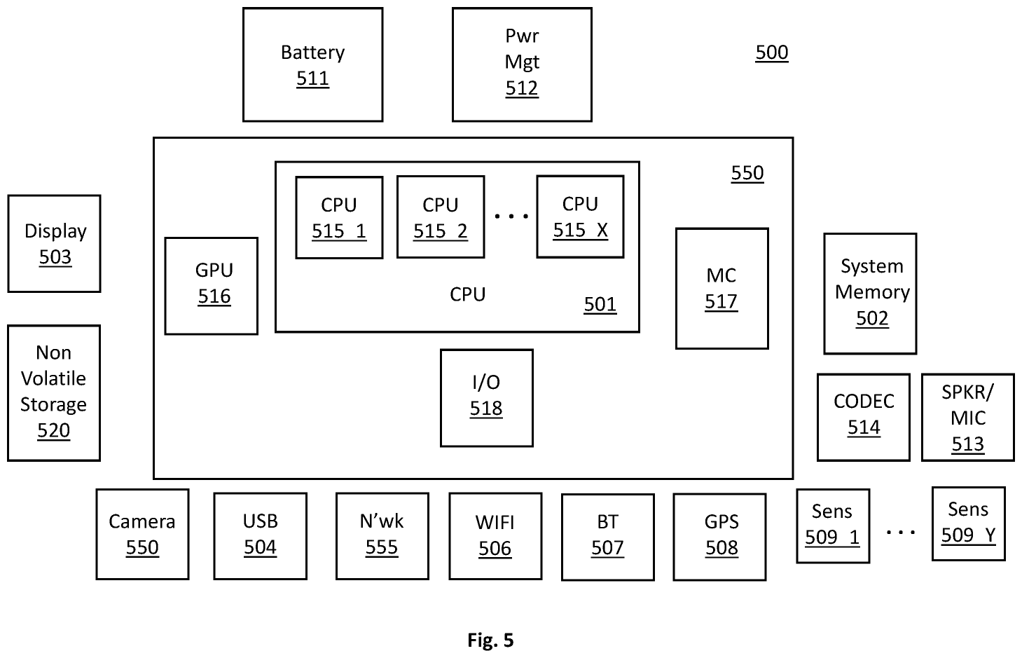

FIG. 5 provides an exemplary depiction of a computing system 500 (e.g., a smartphone, a tablet computer, a laptop computer, a desktop computer, a server computer, etc.). As observed in FIG. 5, the basic computing system 500 may include a central processing unit 501 (which may include, e.g., a plurality of general purpose processing cores 515_1 through 515_X) and a main memory controller 517 disposed on a multi-core processor or applications processor, system memory 502, a display 503 (e.g., touchscreen, flat-panel), a local wired point-to-point link (e.g., USB) interface 504, various network I/O functions 505 (such as an Ethernet interface and/or cellular modem subsystem), a wireless local area network (e.g., WiFi) interface 506, a wireless point-to-point link (e.g., Bluetooth) interface 507 and a Global Positioning System interface 508, various sensors 509_1 through 509_Y, one or more cameras 510, a battery 511, a power management control unit 512, a speaker and microphone 513 and an audio coder/decoder 514.

An applications processor or multi-core processor 550 may include one or more general purpose processing cores 515 within its CPU 501, one or more graphical processing units 516, a memory management function 517 (e.g., a memory controller) and an I/O control function 518. The general purpose processing cores 515 typically execute the system and application software of the computing system. The graphics processing unit 516 typically executes graphics intensive functions to, e.g., generate graphics information that is presented on the display 503. The memory control function 517 interfaces with the system memory 502 to write/read data to/from system memory 502.

The memory control function (memory controller) can include logic circuitry to implement a memory side cache eviction algorithm, as described at length above, that favors keeping items that are expected to be written to in the memory side cache above items that are expected to only be read from, and/or, set different speed settings to different regions of NVRAM where the access times of the respective NVRAM regions are determined at least in part by setting their respective temperatures.

Each of the touchscreen display 503, the communication interfaces 504-507, the GPS interface 508, the sensors 509, the camera(s) 510, and the speaker/microphone codec 513, 514 all can be viewed as various forms of I/O (input and/or output) relative to the overall computing system including, where appropriate, an integrated peripheral device as well (e.g., the one or more cameras 510). Depending on implementation, various ones of these I/O components may be integrated on the applications processor/multi-core processor 550 or may be located off the die or outside the package of the applications processor/multi-core processor 550. The power management control unit 512 generally controls the power consumption of the system 500.

Embodiments of the invention may include various processes as set forth above. The processes may be embodied in machine-executable instructions. The instructions can be used to cause a general-purpose or special-purpose processor to perform certain processes. Alternatively, these processes may be performed by specific/custom hardware components that contain hardwired logic circuitry or programmable logic circuitry (e.g., FPGA, PLD) for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed:

1. An apparatus, comprising:
a memory controller to interface with a memory side cache and an NVRAM system memory, the memory controller comprising logic circuitry to favor items cached in the memory side cache that are expected to be written to above items cached in the memory side cache that are expected to only be read from.

2. The apparatus of claim 1 wherein the NVRAM system memory is an embedded system memory.

3. The apparatus of claim 1 wherein the logic circuitry is coupled to register space that specifies an indicator of how much the logic circuitry is to favor the items cached in the memory side cache that are expected to be written to above the items cached in the memory side cache that are expected to only be read from.

4. The apparatus of claim 1 wherein the memory side cache is to include meta-data for an LRU eviction policy.

5. The apparatus of claim 4 wherein the meta-data comprises more than one bit.

6. The apparatus of claim 1 wherein the memory side cache is to include meta-data for an LFU eviction policy.

7. The apparatus of claim 6 wherein the meta-data comprises more than one bit.

8. A computing system, comprising:
a plurality of processing cores;
an NVRAM system memory;
a memory controller to interface with a memory side cache and the NVRAM system memory, the memory controller comprising logic circuitry to favor items cached in the memory side cache that are expected to be written to above items cached in the memory side cache that are expected to only be read from; and,
a networking interface.

9. The computing system of claim 1 wherein the NVRAM system memory is an embedded system memory.

10. The computing system of claim 8 wherein the logic circuitry is coupled to register space that specifies an indicator of how much the logic circuitry is to favor the items cached in the memory side cache that are expected to be written to above the items cached in the memory side cache that are expected to only be read from.

11. The computing system of claim 8 wherein the memory side cache is to include meta-data for an LRU eviction policy.

12. The computing system of claim 11 wherein the meta-data comprises more than one bit.

13. The computing system of claim 8 wherein the memory side cache is to include meta-data for an LFU eviction policy.

14. The computing system of claim 13 wherein the meta-data comprises more than one bit.

15. An apparatus, comprising:
a memory controller to interface with an NVRAM system memory comprised of different regions, each of the regions having a respective heating element and different speed states based on a setting of the respective heating element.

16. The apparatus of claim 15 wherein the memory controller includes logic circuitry to set different ones of the speed settings to different ones of the different regions.

17. The apparatus of claim 16 wherein the different speed settings are set through programmable register space.

18. The apparatus of claim 15 wherein the memory controller is to interface with a memory side cache and an NVRAM system memory, the memory controller comprising logic circuitry to favor items cached in the memory side cache that are expected to be written to above items cached in the memory side cache that are expected to only be read from.

19. The apparatus of claim 16 wherein the SOC is to assist software in placing more frequently used pages in a region of the NVRAM with a higher speed rating.

20. The apparatus of claim 16 wherein the SOC is to assist software in placing less frequently used pages in a region of the NVRAM with a lower speed rating.
